(19) United States
(12) Patent Application Publication
(10) Pub. No.: US 2018/0232824 A1
(43) Pub. Date: Aug. 16, 2018

(54) METHOD AND APPARATUS FOR SEARCHING FOR REAL ESTATE PROPERTY FOR SALE OR RENT

(71) Applicant: NAVER CORPORATION, Seongnam-si (KR)

(72) Inventors: Gu Hyun KANG, Seongnam-si (KR); Kyung Sung SHON, Seongnam-si (JP); Hyun Tak SUNG, Seongnam-si (KR)

(21) Appl. No.: 15/953,060

(22) Filed: Apr. 13, 2018

Related U.S. Application Data
(63) Continuation of application No. PCT/KR2016/010883, filed on Sep. 29, 2016.

(30) Foreign Application Priority Data
Oct. 15, 2015 (KR) 10-2015-0144314

(51) Int. Cl. G06Q 50/16; G06Q 30/06

(52) U.S. Cl. CPC G06Q 50/16; G06Q 30/0643; G06Q 30/0627

(57) ABSTRACT

Provided is a method of searching for a house for sale or rent, the method including: receiving, from a user terminal, by an apparatus for searching for a house for sale or rent, a first place that is a destination, and a house search condition; extracting from a public transportation service at least one route passing an arrival station corresponding to the first place; extracting at least one available boarding station satisfying the house search condition from at least one station on the at least one route; and extracting at least one house for sale or rent having a pre-set relationship with the at least one available boarding station.

### TECHNICAL FIELD

The present disclosure relates to a method and apparatus for searching for a house for sale or rent, and more particularly, to a method and apparatus for searching for a house for sale or rent, wherein the house for sale or rent is searched for by considering a route of public transport according to a time specific condition or a farthest departure-point specific condition.

### BACKGROUND ART

In the past, in order to obtain information about houses for sale or rent, people had to personally visit a real estate agent's office to check properties for sale. However, with the development of Internet technology, people are now able to easily obtain the information about houses for sale or rent without having to visit a local real estate agent's office.

In order to obtain information about houses for sale or rent in a desired area through the Internet, houses for sale or rent are searched for based on administrative districts, such as a city, a province, and a county. Here, the houses for sale or rent are generally searched for by also considering a route of public transport for convenience of movement.

Conventional technologies are inconvenient since people have to search for public transport connecting houses for sale or rent and their workplaces, separately from searching for the houses for sale or rent, and such searches take a lot of time.

### DETAILED DESCRIPTION OF THE INVENTION

### Technical Problem

Provided are a method and apparatus for searching for a house for sale or rent. In detail, provided are a method and apparatus for searching for a house for sale or rent, wherein the house for sale or rent is searched for by considering a route of public transport according to a time specific condition or a farthest departure-point specific condition.

Also, provided are a method and apparatus for searching for a house for sale or rent, wherein public transportation related to a destination is searched for, and a house for sale or rent near public transportation stops is searched for.

Also, provided are a method and apparatus for searching for a house for sale or rent, wherein a route of public transportation related to a destination is extracted, and a house for sale or rent near stations of the route is searched for.

### Technical Solution

According to an aspect of an embodiment, a method of searching for a house for sale or rent, the method includes: receiving, from a user terminal, by an apparatus for searching for a house for sale or rent, a first place that is a destination, and a house search condition; extracting at least one route passing an arrival station corresponding to the first place; extracting at least one available boarding station satisfying the house search condition from at least one station on the at least one route; and extracting at least one house for sale or rent having a pre-set relationship with the at least one available boarding station.

According to an aspect of another embodiment, an apparatus for searching for a house for sale or rent, the apparatus includes: a receiver configured to receive, from a user terminal, a first place that is a destination, and a house search condition; a transportation information extractor configured to extract at least one route passing an arrival station corresponding to the first place; an available boarding station extractor configured to extract at least one available boarding station satisfying the house search condition from at least one station on the at least one route; and a house extractor configured to extract at least one house for sale or rent having a pre-set relationship with the at least one available boarding station.

These and/or other aspects will become apparent and more readily appreciated from the following description of the embodiments, taken in conjunction with the accompanying drawings.

These general and specific embodiments may be implemented by using a system, a method, a computer program, or a combination of the system, the method, and the computer program.

### Advantageous Effects of the Invention

A house for sale or rent may be searched for by considering a route of public transport according to a time specific condition or a farthest departure-point specific condition.

Also, public transportation related to a destination may be searched for, and a house for sale or rent near public transportation stops may be searched for.

Also, a route of public transportation related to a destination may be extracted, and a house for sale or rent near stations of the route may be searched for.

### DESCRIPTION OF THE DRAWINGS

FIG. 1 is a diagram of a configuration of a system for searching for a house for sale or rent, according to an embodiment.

FIG. 2 is a block diagram of a configuration of an apparatus for searching for a house for sale or rent, included in a server of FIG. 1.

FIG. 3 is a flowchart of a method of searching for a house for sale or rent, according to an embodiment.

FIGS. 4A and 4B illustrate screens (or graphical user interfaces (GUIs)) of a user terminal, into which a first place, i.e., a destination, and a house search condition are input, according to embodiments.

FIGS. 5A and 5B illustrate house search result screens (GUIs) provided to a user terminal, according to embodiments.

FIG. 6 illustrates a search result screen (GUI) displaying information about houses for sale or rent on a map.

### MODE OF THE INVENTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description.

In the drawings, like reference numerals refer to like elements throughout, and overlapping descriptions shall not be repeated.

While such terms as “first”, “second”, etc., may be used to describe various components, such components must not be limited to the above terms. The above terms are used only to distinguish one component from another. An expression used in the singular encompasses the expression of the plural, unless it has a clearly different meaning in the context. In the present specification, it is to be understood that terms such as “including” or “having,” etc., are intended to indicate the existence of features or components, and are not intended to preclude the possibility that one or more other features or components may exist or may be added. In the drawings, for convenience of description, sizes of components may be exaggerated for clarity. For example, since sizes and thicknesses of components in drawings are arbitrarily shown for convenience of description, the sizes and thicknesses are not limited thereto.

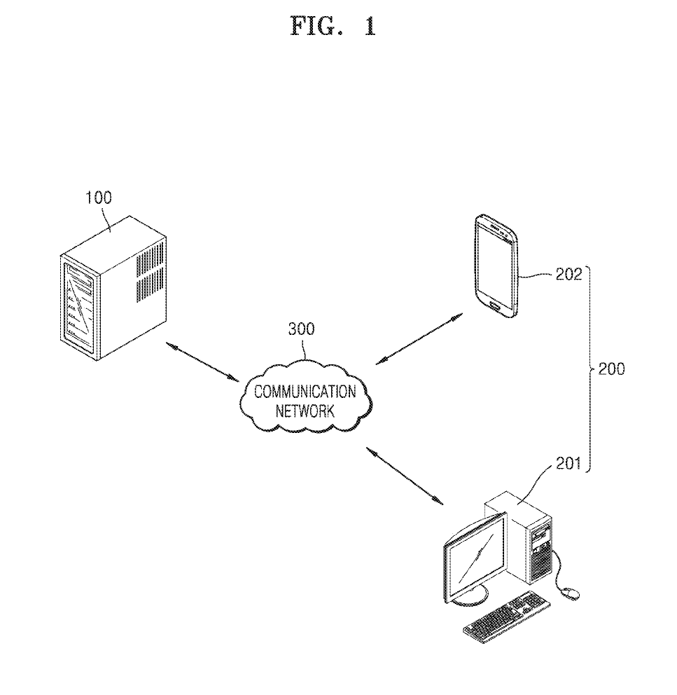

FIG. 1 is a diagram of a configuration of a system for searching for a house for sale or rent, according to an embodiment.

Referring to FIG. 1, the system for searching for a house for sale or rent, according to an embodiment provides a house search service. The system according to an embodiment includes a server 100, a user terminal 200, and a communication network 300 connecting the server 100 and the user terminal 200.

The system according to an embodiment may provide a house search program or a house search website to the user terminal 200. The system according to an embodiment searches for a house for sale or rent by receiving a destination and a house search condition from the user terminal 200, and provides a search result to the user terminal 200.

Referring to FIG. 1, the user terminal 200 denotes a communication terminal using a web service in a wired/wireless communication environment. The user terminal 200 may be a personal computer (PC) 201 or a portable terminal 202. In FIG. 1, the portable terminal 202 is illustrated as a smart phone, but embodiments are not limited thereto, and a terminal, on which an application capable of web browsing as described above is mounted, may be unlimitedly used.

The user terminal 200 includes a display unit displaying a screen, an input device receiving data from a user, and a communication unit. The input device may include, for example, a keyboard, a mouse, a track ball, a microphone, a button, a touch panel, or the like, but is not limited thereto.

The communication network 300 performs a function of connecting the server 100 and the user terminal 200. For example, the communication network provides an access path for the server 100 and the user terminal 200 to access and exchange packet data with each other. The communication network may consist of any network over which data can be transmitted, such as the internet.

The server 100 provides, to the user terminal 200, a webpage providing the house search program and/or the house search service. For example, the server 100 may receive a condition related to a search from the user terminal 200 and provide a house search result according to the condition, through the webpage providing the house search program or the house search service.

The server 100 may receive a house search result from the user terminal 200, and provide a house search result corresponding to the house search request. At this time, the house search request may include a condition for searching for a house for sale or rent. In detail, the condition may include location information, a transaction type, price information, area information, total household number information, average maintenance cost information, public transportation station influence area information, and move-in date information.

The server 100 may search for and provide a house for sale or rent that matches a condition included in the house search request, in response to the house search request. Also, the server 100 may provide a floor plan, a site photograph, a real estate agency, a feature, etc. of at least one registered house for sale or rent.

Although not illustrated, the server 100 according to an embodiment may include a memory, an input/output unit, a program storage unit, a controller, a communication unit, etc. The memory temporarily or permanently stores data processed by the server 100. The memory may include a magnetic storage medium or a flash storage medium, but the range of the present disclosure is not limited thereto. The communication unit may be a device including hardware and software required to transmit or receive a signal, such as a control signal or a data signal, through wired/wireless connection with another network device. The controller may include any type of device capable of processing data, such as a computer processor. Here, a ‘processor’ may be, for example, a data processing device embedded in hardware and having a physically structured circuit to perform a function expressed in a code or command included in a program. As such, examples of the data processing device embedded in hardware may include a microprocessor, a central processing unit (CPU), a processor core, a multiprocessor, an application-specific integrated circuit (ASIC), and a field programmable gate array (FPGA), but the present disclosure is not limited thereto.

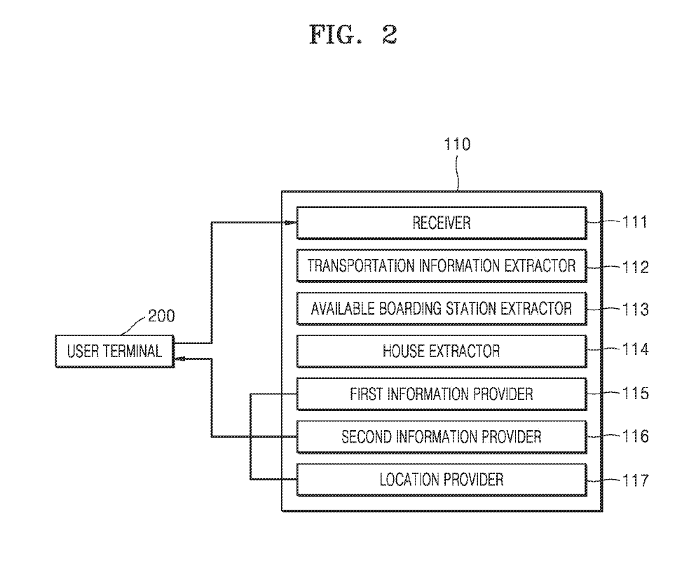

FIG. 2 is a block diagram of a configuration of an apparatus 110 for searching for a house for sale or rent, included in the server 100 of FIG. 1.

The apparatus 110 according to an embodiment may correspond to at least one processor or may include at least one processor. Accordingly, the apparatus 110 may be driven while being included in another hardware device, such as a general-purpose computer system. The apparatus 110 may be included in the server 100, but the present disclosure is not limited thereto, and the apparatus 110 may be included in the user terminal 200 based on a design.

The apparatus 110 according to an embodiment receives a first place, i.e., a destination, and a house search condition, from the user terminal 200. The apparatus 110 extracts an arrival station corresponding to the first place, i.e., an arrival station adjacent to the destination or within a predetermined distance from the destination (wherein “station” refers to a regular stopping place of a public transportation service, such as a bus service, a train service, a subway service, etc.). The apparatus 110 obtains at least one route passing through the arrival station. The apparatus 110 extracts at least one available boarding station satisfying the house search condition, from at least one station on the at least one route. The apparatus 110 may extract at least one house for sale or rent in a pre-set relationship (such as within a predetermined distance) with the at least one available boarding station, and provide the at least one house for sale or rent to the user terminal 200.

The apparatus 110 according to an embodiment may include a receiver 111, a transportation information extractor 112, an available boarding station extractor 113, a house extractor 114, a first information provider 115, a second information provider 116, and a location provider 117.

The receiver 111 according to an embodiment receives the first place, i.e., the destination, and the house search condition from the user terminal 200, as input by the user into the user terminal.

The first place may be a location designated by a user. In other words, the first place may be a particular location selected on a map, a particular place name input by the user, or a location corresponding to a particular address.

For example, the receiver 111 may receive, from the user terminal, a location the user visits frequently as the first place. For example, the first place may be a place where the user's workplace or school is located.

Meanwhile, the house search condition denotes a condition used while searching for a house for sale or rent, and may include a transaction type, a house type, a time specific condition, a farthest departure-point specific condition, etc.

The transaction type may include at least one of lease, sale, and monthly rent (such as a monthly rent range or rent maximum). The house type may include at least one of an apartment, a row house, and a detached house. For example, the house search condition of the user may include ‘apartment’ as the house type and ‘lease’ as the transaction type.

The time specific condition may be a condition in which a travel time from a particular house to the destination is within a time set by the user (i.e., a maximum travel time). In other words, a house from which a travel time to the destination exceeds the time set by the user may be excluded according to the time specific condition. For example, when the time specific condition is ‘30 minutes’, the apparatus 110 according to an embodiment may extract only a house from which a travel time is within 30 minutes to the destination, excluding a house from which a travel time to the destination exceeds 30 minutes.

The farthest departure-point specific condition may be a condition of excluding, from search targets, a house farther than a farthest departure-point in a direction from the destination to the farthest departure-point or a house in a direction different from the farthest departure-point to the destination. In other words, specifying the farthest departure-point may denote assigning a range as an approximate direction and an approximate distance for a house search. For example, the destination may be ‘Gangnam District Office’ and the farthest departure-point may be ‘Konkuk University’.

The receiver 111 may further receive a second place, i.e., the farthest departure-point, in addition to the first place, when the house search condition is the ‘farthest departure-point specific condition’.

The second place may be a location designated by the user, like the first place. In other words, the second place may be a particular location selected on the map, a particular place name input by the user, or a location corresponding to a particular address.

The transportation information extractor 112 extracts at least one route passing the arrival station corresponding to the first place, i.e., the destination.

In the present disclosure, a ‘station’ denotes any point where a person may get on or off any type of public transport, such as a subway station, a railway station, a bus station, or an airport. Accordingly, a ‘route’ may include a subway route, a train route, a bus route, or an airplane route.

The arrival station corresponding to the first place may be a station within a pre-set second threshold distance from the first place received from the user terminal 200. The second threshold distance, i.e., a distance between the first place and the arrival station may be set based on user convenience (such as an easily walkable distance or an easily drivable distance). For example, the second threshold distance may be a walkable distance for a person, and in this case, the second threshold distance may be set to any desired predetermined distance, such as 200 meters, 500 meters, 1000 meters, 1500 meters, 2000 meters, etc. As another example, the second threshold distance may be a convenient drivable distance for a person, and in this case, the second threshold distance may be set to any desired predetermined distance, such as 15 kilometers or 25 kilometers or 35 kilometers, etc.

Accordingly, the transportation information extractor 112 may extract a bus station, a subway station, etc. located within the pre-set second threshold distance from the first place, and may extract at least one route passing the bus station or the subway station. Here, transportation information extractor 112 may extract the bus station, the subway station and route from the database previously stored in a memory or a transportation service website accessed via a network such as the internet.

For example, when the first place is ‘Gangnam District Office’ and both Gangnam District Office subway station and bus station are within the second threshold distance (for example, 200 meters) from ‘Gangnam District Office’, the Gangnam District Office subway station and bus station are arrival stations. In this case, the transportation information extractor 112 extracts, as routes passing the arrival station, a subway line no. 7 and a Bundang line, which pass the Gangnam District Office subway station. Also, the transportation information extractor 112 extracts, as routes passing the arrival station, bus numbers 301, 401, and 242, which pass the Gangnam District Office bus station.

When there is no station within the second threshold distance from the first place, the apparatus 110 according to embodiments may replace the second threshold distance with a 2-1^{th} threshold distance that is longer than the second threshold distance, and extract a station located within the 2-1^{th} threshold distance from the first place as the arrival station.

Any one of various well-known technologies may be used to determine a pre-set threshold distance. For example, the apparatus 110 according to embodiments may determine a distance between two places by using a difference on 2-dimensional (2D) coordinate values. The apparatus 110 according to embodiments may calculate a distance between two places by using global positioning system (GPS) coordinates or latitude and longitude coordinates. Also, according to a selective embodiment, the apparatus 110 according to embodiments may divide a map into a plurality of clusters, such as GeoHash, and determine that two places included in a particular cluster are adjacent to each other.

The available boarding station extractor 113 extracts at least one available boarding station satisfying the house search condition, from among the at least one station on the at least one route extracted by the transportation information extractor 112. Here, the house search condition may include, for example, the ‘time specific condition’ or the ‘farthest departure-point specific condition’.

When the house search condition is the ‘time specific condition’, the available boarding station extractor 113 extracts the available boarding station considering a time taken to reach the arrival station. In other words, the available boarding station extractor 113 extracts the available boarding station based on an average travel time from a particular station to the arrival station of a transportation service operating along the route. In detail, the available boarding station extractor 113 may extract, as the available boarding station, a station of which an average travel time to the arrival time is within a pre-set threshold time from among the at least one station included in the at least one route. Here, the threshold time may be set by the user or a manager. Generally, the average travel time to the arrival station may vary depending on a time of day, a day of week, and traffic conditions when moving. For example, an average travel time to the arrival station during a commute time may be set to be longer than an average travel time excluding the commute time, considering traffic. Here, available boarding station extractor 113 may obtain the average travel time during different time periods from the database previously stored in a memory or a transportation service website accessed via a network such as the internet.

For example, as in the above example, when the arrival station is the ‘Gangnam District Office station’ subway station, the route is along ‘subway line no. 7’, and the pre-set threshold time is 10 minutes, the available boarding station extractor 113 may extract, as the available boarding stations, ‘Chungdam station’, ‘Hakdong station’, etc., which are stations on ‘subway line no. 7’ from which average travel times to the ‘Gangnam District Office station’ subway station are within 10 minutes. As an average travel time from ‘Dobongsan station’ on ‘subway line no. 7’ to the ‘Gangnam District Office station’ exceeds 10 minutes, the available boarding station extractor 113 may not extract ‘Dobongsan station’ as the available boarding station.

Meanwhile, when the house search condition is the ‘farthest departure-point specific condition’, the available boarding station extractor 113 extracts the available boarding station based on the second place received by the receiver 111. In detail, the available boarding station extractor 113 may extract, as the available boarding station, at least one station located between the arrival station corresponding to the first place and a departure station corresponding to the second place.

The departure station may include a station within the pre-set first threshold distance from the second place. Here, the first threshold distance, i.e., a distance between the second place and the departure station, may be set according to user convenience. For example, when the first threshold distance is a walkable distance, the first threshold distance may be, for example, 200 meters, or other pre-set distance.

For example, when the arrival station is ‘Gangnam District Office station’ subway station, the route is along ‘subway line no. 7’, the second place is ‘Children's Grand Park’, and there is a ‘Children's Grand Park station’ subway station within the pre-set first threshold distance from ‘Children's Grand Park’, i.e., the second place, the available boarding station extractor 113 may extract, as the available boarding stations, ‘Children's Grand Park station’, ‘Konkuk University station’, ‘Ttukseom Resort station’, ‘Chungdam station’, and ‘Gangnam District Office station’ between the ‘Children's Grand Park station’ and the ‘Gangnam District Office station’ (The route of subway line no. 7 includes the following stations, in order: Children's Grand Park station, Konkuk University station, Ttukseom Resort station, Chungdam station, and Gangnam District Office station).

Meanwhile, the available boarding station extractor 113 may also extract, as the available boarding station, a station along a route that does not pass the arrival station, considering a transfer to another transportation route. In other words, when there is no direct route passing both the departure station and the arrival station, and a particular station is included in both a route passing the departure station and a route passing the arrival station, stations between the departure station and the arrival station, from among stations in the two routes, may be extracted as the available boarding stations. Here, when the house search condition is the ‘time specific condition’, the available boarding station extractor 113 may extract the available boarding station by considering a transfer time of transferring between routes.

The house extractor 114 extracts at least one house for sale or rent in a pre-set relationship with the at least one available boarding station extracted by the available boarding station extractor 113. Here, the pre-set relationship may include a relationship in which a distance difference between a location of the available boarding station and a location of a house for sale or rent is within a pre-set third threshold distance. Meanwhile, the third threshold distance may be set according to user convenience. For example, when the third threshold distance is a walkable distance within 30 minutes, the third threshold distance may be 200 meters.

In the above example, when the house search condition is the ‘farthest departure-point specific condition’, the available boarding station extractor 113 may extract, as the available boarding stations, ‘Children's Grand Park station’, ‘Konkuk University station’, ‘Ttukseom Resort station’, ‘Chungdam station’, and ‘Gangnam District Office station’. In this case, the house extractor 114 extracts at least one house for sale or rent within a pre-set distance from each of ‘Children's Grand Park station’, ‘Konkuk University station’, ‘Ttukseom Resort station’, ‘Chungdam station’, and ‘Gangnam District Office station’.

As such, the apparatus 110 may accurately search for at least one house for sale or rent satisfying the house search condition.

The first information provider 115 may provide, to the user terminal 200, the at least one house for sale or rent in a list form by arranging the at least one house for sale or rent in an order starting from a shortest average travel time to the arrival station. Since the average travel time may vary based on a moving time (i.e., time of day during which the travel occurs), the order of the at least one house for sale or rent may also vary based on a moving time (time of day, or range of times) set by the user.

Meanwhile, the second information provider 116 according to an embodiment may provide, to the user terminal 200, the at least one house for sale or rent in a list form by arranging the at least one house for sale or rent in an order starting from a shortest distance to the arrival station.

The first and second information providers 115 and 116 described above are only examples, and any one of various methods, such as providing, to the user terminal 200, a list of houses for sale or rent by arranging stations between the departure station and the arrival station in a descending order of the number of stations, may be used but embodiments are not limited thereto.

The location provider 117 according to an embodiment may provide a map to the user terminal 200 after displaying, on the map, the at least one house for sale or rent in correspondence with a location of the at least one house for sale or rent, and displaying, on the map, the at least one route and the at least one available boarding station. Here, the location provider 117 may obtain the map from the database previously stored in a memory or a map service website accessed via a network such as the internet. In other words, the at least one route extracted by the transportation information extractor 112, the at least one available boarding station extracted by the available boarding station extractor 113, the at least one house for sale or rent extracted by the house extractor 114, etc. may be displayed on the map and the map may be transmitted to the user terminal 200. Here, the location provider 117 may generate an image indicating an attribute of the at least one house for sale or rent and the number of houses for sale or rent associated with various sections of the map, in correspondence with the at least one house for sale or rent, and provide, to the user terminal 200, a display screen displaying the image. Meanwhile, the attribute of the house for sale or rent provided by the location provider 117 may include a transaction type, a house type, etc. The display screen provided by the location provider 117 may include, at a location on a map, where the at least one house for sale or rent exists, an image having a size that changes (increases or decreases) according to the overall number of houses for sale or rent at that location. In other words, the size of the image at the location on the map where the at least one house for sale or rent exists may be proportional to the number of houses for sale or rent at that location, such as by increasing in proportion to the number of houses for rent or sale. Also, a color of the image at the location on the map where the at least one house for sale or rent exists may vary based on a house type or a transaction type of the at least one house for sale or rent.

The image corresponding to the at least one house for sale or rent on the map may include different types of information based on the scale of the map. For example, when the scale of the map is small (when a reduction ratio of the map is low) and thus detailed house information is verifiable, an image corresponding to the at least one house for sale or rent on the map may be generated in correspondence with each house for sale or rent. However, when the scale of the map is large (when the reduction ratio of the map is high) and thus detailed house information is not verifiable, one image corresponding to the at least one house for sale or rent on the map including information about the at least one house for sale or rent at the location of the at least one house for sale or rent may be generated. In other words, the image corresponding to the at least one house for sale or rent on the map may be differently generated based on the number of houses for sale or rent at a particular location, a transaction type of a house for sale or rent, a price of a house for sale or rent, etc.

Hereinafter, processes of searching for a house for sale or rent with respect to a plurality of destinations, by using the apparatus 110 described above, will be described.

The apparatus 110 according to an embodiment may search for a house for sale or rent with respect to a plurality of arrival stations. In other words, the apparatus 110 according to an embodiment may search for public transportation, offered from one or more public transportation services, passing through each of the plurality of arrival stations, and search for all houses for sale or rent available in the vicinity of the relevant public transportation service.

For example, in this scenario, it will be assumed that a house for sale or rent is to be searched for in consideration of a workplace of a first family member and a school of a second family member.

The receiver 111 receives a first destination where the workplace of the first family member is located and a second destination where the school of the second family member is located.

The transportation information extractor 112 extracts a first arrival station corresponding to the first destination and at least one route passing the first arrival station. Also, the transportation information extractor 112 extracts a second arrival station corresponding to the second destination and at least one route passing the second arrival station.

The available boarding station extractor 113 extracts at least one first available boarding station with respect to the first arrival station and at least one second available boarding station with respect to the second arrival station.

The house extractor 114 extracts at least one house for sale or rent in a pre-set relationship with a first adjacent station or a second adjacent station, when a distance between a location of the first adjacent station and a location of the second adjacent station is smaller than a pre-set fourth threshold distance. Here, the first adjacent station is a station included in the at least one first available boarding station and the second adjacent station is a station included in the at least one second available boarding station. Here, the fourth threshold distance may be set in the same manner as the first threshold distance described above.

For example, when the receiver 111 received ‘Konkuk University’ as the first destination and ‘Seolleung’ as the second destination, the transportation information extractor 112 may extract, as the first arrival station, ‘Konkuk University station’ with respect to ‘Konkuk University’, i.e., the first destination, and extract ‘subway line no. 7’ passing ‘Konkuk University station’. Similarly, the transportation information extractor 112 extracts, as the second arrival station, ‘Seolleung station’ with respect to ‘Seolleung’, i.e., the second destination, and extract ‘Bundang line’ passing ‘Seolleung station’.

The available boarding station extractor 113 extracts, from ‘subway line no. 7’, the first available boarding station satisfying a house search condition with respect to ‘Konkuk University station’, i.e., a first boarding station, and extracts, from ‘Bundang line’, the second available boarding station satisfying the house search condition with respect to ‘Seolleung station’, i.e., a second boarding station.

The house extractor 114 extracts at least one house for sale or rent in the pre-set relationship with ‘Gangnam District Office station’ when a distance difference between a location of ‘Gangnam District Office station’ on subway line no. 7 (i.e., one of the at least one first available boarding station) and a location of ‘Gangnam District Office station’ of Bundang line (i.e., one of the at least one second available boarding station) are both within the pre-set fourth threshold value.

As such, a desired house for sale or rent may be conveniently searched for with respect to a plurality of destinations.

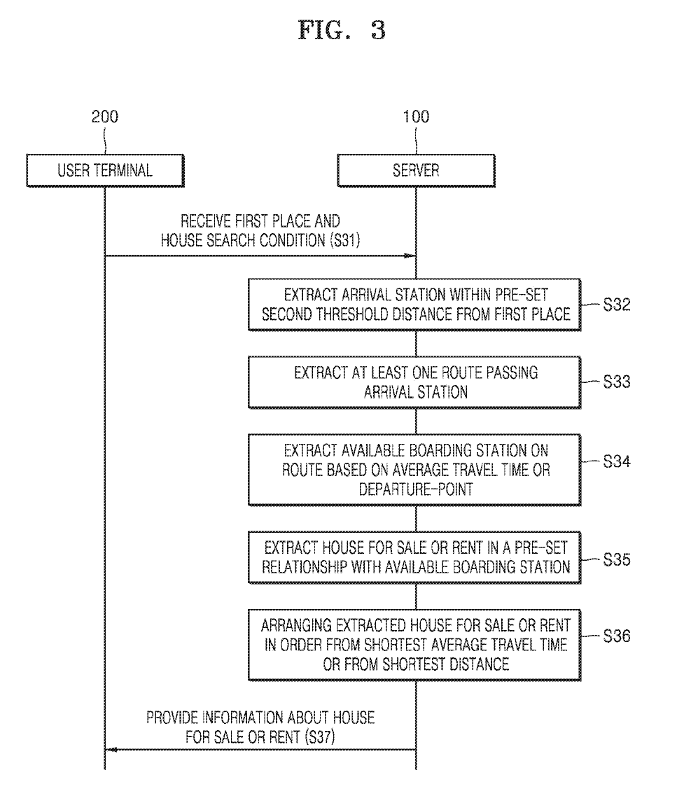

FIG. 3 is a flowchart of a method of searching for a house for sale or rent, according to an embodiment.

Referring to FIG. 3, a flowchart of a method of processing information between the server 100 and the user terminal 200 is illustrated. Meanwhile, since the server 100 of FIG. 3 may include the apparatus 110 of FIG. 2, details described with reference to the apparatus 110 of FIG. 2 may be applied to those of FIG. 3, which details are omitted hereinbelow.

Referring to FIG. 3, the user terminal 200 transmits, to the server 100, a first place, i.e., a destination, and a house search condition, in operation S31. Here, the house search condition is a condition used while a house for sale or rent is searched for, and may include a transaction type, a house type, a time specific condition, a farthest departure-point specific condition, etc.

The server 100 extracts an arrival station within a pre-set second threshold distance from the first place, in operation S32. Herein, a ‘station’ denotes any point where a person may get on or off any type of public transport, such as a subway station, a railway station, or a bus station, and thus the arrival station may be a subway station, railway station, or a bus station.

In operation S33, the server 100 obtains at least one route passing the arrival station extracted in operation S32. Here, the ‘route’ may include a subway route, a bus route, a railway route or an airplane route.

The server 100 extracts an available boarding station from the at least one route in operation S34, based on an average travel time from a station on the at least one route extracted in operation S33 to the arrival station or based on a farthest departure-point received from the user terminal 200. In other words, when the house search condition is the ‘time specific condition’, the server 100 extracts the available boarding station considering a time taken to the arrival station. Meanwhile, when the house search condition is the ‘farthest departure-point specific condition’, the server 100 extracts, as the available boarding station, at least one station between a farthest departure station and the arrival station. Here, the farthest departure station is a station within a pre-set first threshold distance from the farthest departure-point received by the server 100, and may be at least one station located on the route described above.

In operation S35, the server 100 extracts a house for sale or rent in a pre-set relationship with the available boarding station extracted in operation S34. Here, the pre-set relationship may be a relationship in which a difference between a location of the available boarding station and a location of the house for sale or rent is within a pre-set third threshold distance.

The server 100 may arrange the at least one house for sale or rent extracted in operation S35 in order starting from a shortest average travel time or starting from a shortest distance from the arrival station, and transmit information about the arranged at least one house for sale or rent to the user terminal 200 in operation S37.

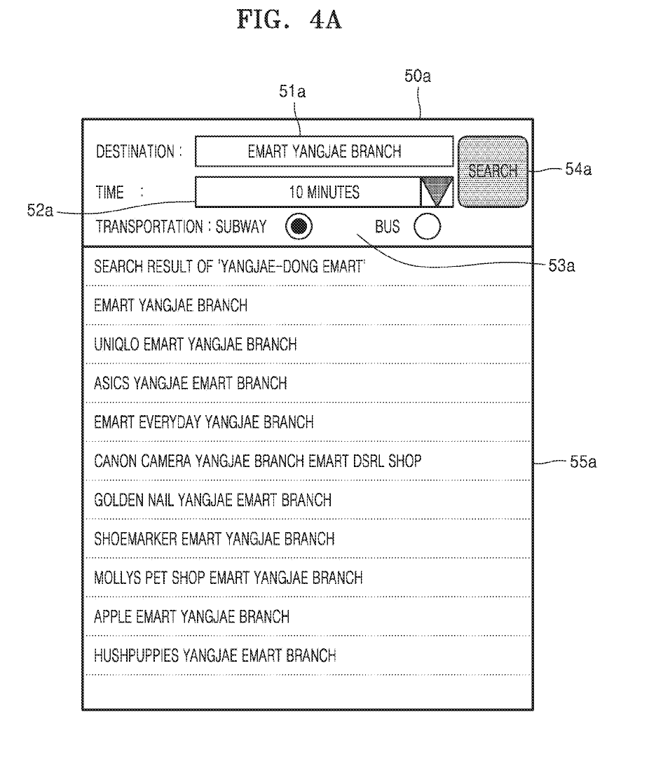

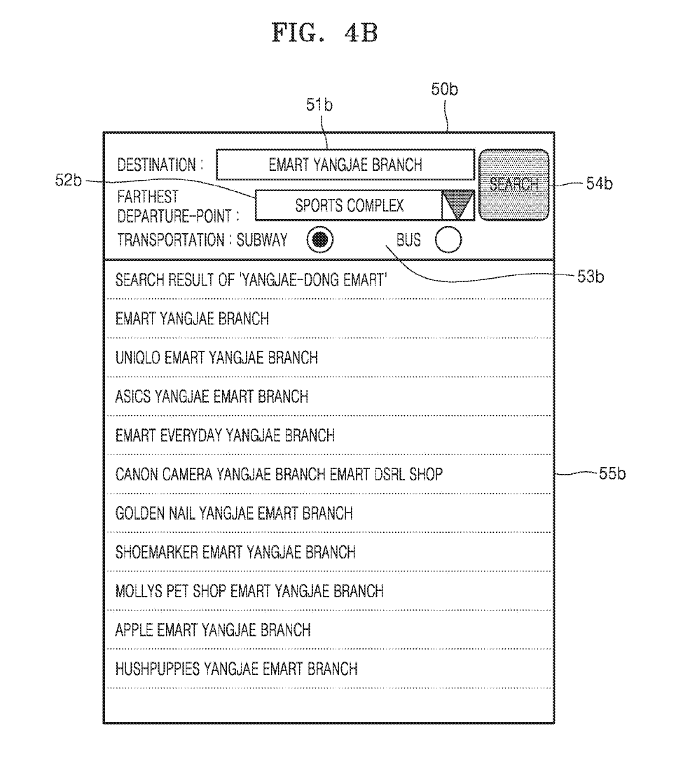

FIGS. 4 through 6 illustrate screens (GUIs) displayed on the user terminal 200, according to embodiments.

FIGS. 4A and 4B illustrate screens of the user terminal 200, into which a first place, i.e., a destination, and a house search condition are input, according to embodiments.

FIG. 4A is a screen 50a into which the first place, i.e., the destination, and detailed house search condition are input when the house search condition is a ‘time specific condition’. The screen 50a includes a destination input window 51a into which the destination is input, a time input window 52a into which the time specific condition (such as maximum travel time) is input, a check box 53a selecting the type of public transportation, a search button 54a for inputting a search command, and a search result display window 55a for displaying a search result of the destination.

FIG. 4B is a screen 50b into which the first place, i.e., the destination, and the detailed house search condition are input when the house search condition is a ‘farthest departure-point specific condition’. The screen 50b includes a destination input window 51b into which the destination is input, a farthest departure-point input window 52b into which a condition is input, a check box 53b selecting the type of public transportation, a search button 54b for inputting a search command, and a search result display window 55b displaying a search result of the destination.

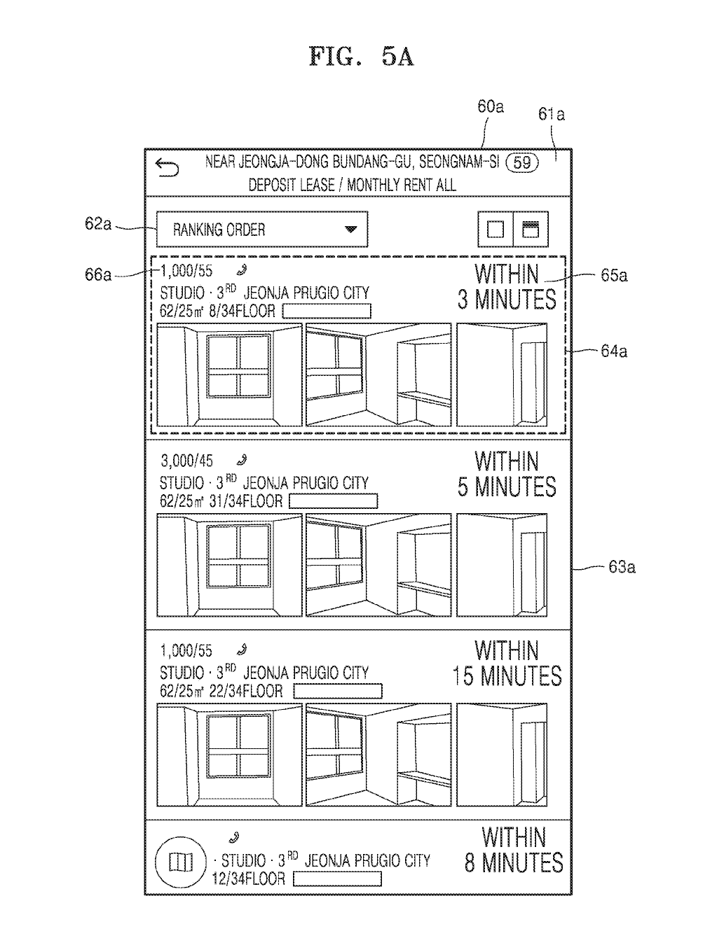

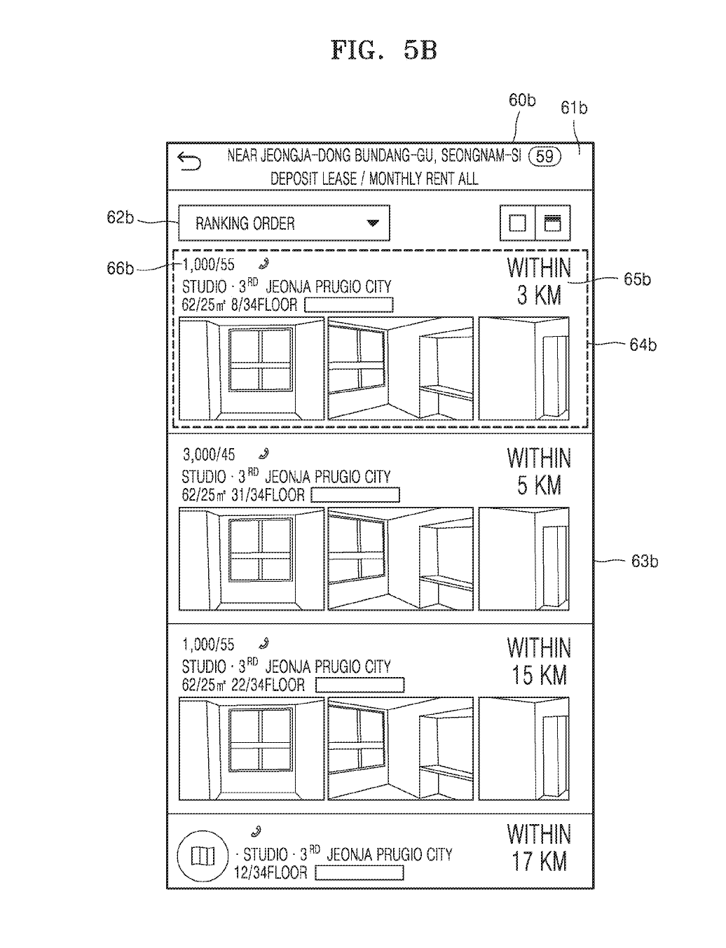

FIGS. 5A and 5B illustrate house search result screens provided to the user terminal 200, according to embodiments.

FIG. 5A is a search result screen 60a when a house search condition is ‘time specific condition’. The search result screen 60a may include a display window 61a where an approximate address of a destination is displayed, a dropdown box 62a for selecting a method of arranging search results of houses for sale or rent, and a search result display window 63a displaying the search results. The search result display window 63a may include a plurality of display windows 64a respectively for houses for sale or rent, where a plurality of houses for sale or rent are distinguishably displayed (including photographs, drawings or other images). The display window 64a may include a display 65a regarding a travel time from the corresponding house and a terms and conditions of business 66a (such as monthly rent, deposit required, size of unit, type of unit, etc.) of the corresponding house.

FIG. 5B is a search result screen 60b when a house search condition is ‘farthest departure-point specific condition’. The search result screen 60b may include a display window 61b where an approximate address of a destination is displayed, a dropdown box 62b for selecting a method of arranging search results of houses for sale or rent, and a search result display window 63b displaying search results. The search result display window 63b may include a plurality of display windows 64b respectively for houses for sale or rent, where a plurality of houses for sale or rent are distinguishably displayed (including photographs, drawings or other images). The display window 64b may include a display 65b regarding a distance from the corresponding house and a terms and conditions of business 66b (such as monthly rent, deposit required, size of unit, type of unit, etc.) of the corresponding house.

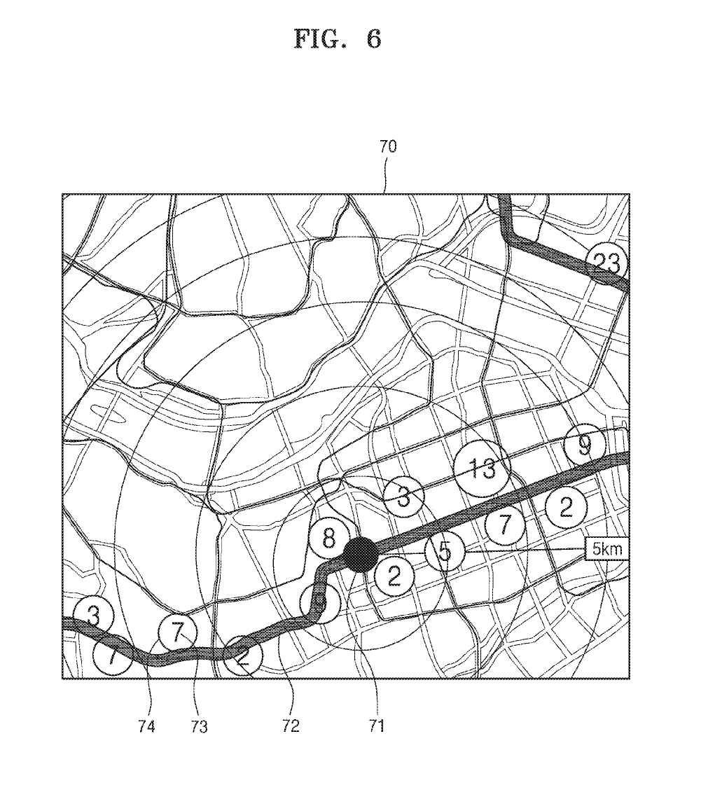

FIG. 6 illustrates a search result screen 70 displaying information about houses for sale or rent on a map. The search result screen 70 may include a map centered on a destination 71, an arrival station (not shown) near a destination, and a route 72 of public transportation passing an arrival station.

Here, the search result screen 70 may include an image including an attribute of a house for sale or rent and the number of houses for sale or rent, wherein the image is displayed at a location of each house for sale or rent. Here, the displayed attribute of the house for sale or rent may include a transaction type, a house type, etc.

Meanwhile, the search result screen 70 may include, at a location where houses for sale or rent exist, an image having a size that changes according to the number of the houses for sale or rent at that location. In other words, the size of the image at the location where the houses for sale or rent exist may be proportional to the number of houses for sale or rent. Also, a color of the image at the location where the houses for sale or rent exist may vary based on a house type or a transaction type of the houses for sale or rent.

Meanwhile, the image corresponding to the houses for sale or rent on the map may include different types of information based on the scale of the map. For example, when the scale of the map is small (when a reduction ratio of the map is low) and thus detailed house information is verifiable (i.e., the information can be legibly represented), the image corresponding to the at least one house for sale or rent on the map may be generated in correspondence with each house for sale or rent. However, when the scale of the map is large (when the reduction ratio of the map is high) and thus detailed house information is not verifiable (i.e., the information for each house cannot be legibly represented), one image corresponding to the at least one house for sale or rent on the map including information about the at least one house for sale or rent at the location of a plurality of the houses for sale or rent may be generated. In other words, the image corresponding to the at least one house for sale or rent on the map may be differently generated based on the number of houses for sale or rent at a particular location, a transaction type of a house for sale or rent, a price of a house for sale or rent, etc.

Meanwhile, the method of searching for houses for sale or rent, according to an embodiment of the present disclosure shown in FIG. 3 can be written as computer programs and can be implemented in general-use digital computers that execute the programs using a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

It should be understood that embodiments described herein should be considered in a descriptive sense only and not for purposes of limitation. Descriptions of features or aspects within each embodiment should typically be considered as available for other similar features or aspects in other embodiments.

1. A method of searching for a house for sale or rent, the method comprising:
receiving, from a user terminal, by an apparatus for searching for a house for sale or rent, a first place that is a destination, and a house search condition;
extracting at least one route of a public transportation service passing an arrival station corresponding to the first place;
extracting at least one available boarding station satisfying the house search condition from at least one station on the at least one route; and
extracting at least one house for sale or rent having a pre-set relationship with the at least one available boarding station.

2. The method of claim 1, wherein the house search condition is a condition of searching for a station of which an average travel time from the at least one available boarding station to the arrival station is within a pre-set threshold time when a transportation service operating along the at least one route is used.

3. The method of claim 2, further comprising providing the at least one house for sale or rent in a list form by arranging the at least one house for sale or rent in an order starting from a shortest travel time to the arrival station.

4. The method of claim 1, wherein the house search condition is a condition of searching among the at least one station on the at least one route for at least one station between a departure station and the arrival station,
wherein the departure station is within a pre-set first threshold distance from a second place that is a farthest departure-point, the second place being received from the user terminal, and is at least one station located on the at least one route.

5. The method of claim 4, further comprising providing the at least one house for sale or rent in a list form by arranging the at least one house for sale or rent in an order starting from a shortest distance from the arrival station.

6. The method of claim 1, wherein the arrival station corresponding to the first place comprises at least one station located within a pre-set second threshold distance from the first place received from the user terminal.

7. The method of claim 1, wherein the pre-set relationship is within a pre-set third threshold distance from the at least one available boarding station.

8. The method of claim 1, further comprising providing a map to the user terminal after displaying, on the map, the at least one house for sale or rent in correspondence with a location of the at least one house for sale or rent, and displaying, on the map, the at least one route and the at least one available boarding station.

9. The method of claim 8, further comprising providing, to the user terminal, a display window displaying an attribute of the at least one house for sale or rent, the number of houses for sale or rent according to sections of the map, and the overall number of houses for sale or rent associated with each of the sections,
wherein the attribute of the at least one house for sale or rent comprises a transaction type and a house type, and
the size of the display window increases in proportion to the number of houses for sale or rent.

10. The method of claim 1, further comprising:
extracting at least one first available boarding station with respect to a first arrival station and at least one second available boarding station with respect to a second arrival station distinguished from the first arrival station; and
when a distance difference between a location of a first adjacent station included in the at least one first available boarding station and a location of a second adjacent station included in the at least one second available boarding station is within a pre-set fourth threshold distance, extracting at least one house for sale or rent having the pre-set relationship with the first adjacent station or the second adjacent station.

11. The method of claim 1, wherein the house search condition further comprises a transaction type and a house type.

12. The method of claim 1, wherein the at least one route is one of a plurality of routes of public transportation offered by the public transportation service.

13. An apparatus for searching for a house for sale or rent, the apparatus comprising:
a receiver configured to receive, from a user terminal, a first place that is a destination, and a house search condition;
a transportation information extractor configured to extract at least one route from a public transportation service passing an arrival station corresponding to the first place;
an available boarding station extractor configured to extract at least one available boarding station satisfying the house search condition from at least one station on the at least one route; and
a house extractor configured to extract at least one house for sale or rent having a pre-set relationship with the at least one available boarding station.

14. The apparatus of claim 13, wherein the house search condition is a condition of searching for a station of which an average travel time from the at least one available boarding station to the arrival station is within a pre-set threshold time when a transportation service operating along the at least one route is used.

15. The apparatus of claim 14, further comprising a first information provider configured to provide the at least one house for sale or rent in a list form by arranging the at least one house for sale or rent in an order starting from a shortest travel time to the arrival station.

16. The apparatus of claim 13, wherein the house search condition is a condition of searching among the at least one station on the at least one route for at least one station between a departure station and the arrival station,
wherein the departure station is within a pre-set first threshold distance from a second place that is a farthest departure-point, the second place being received from the user terminal, and is at least one station located on the at least one route.

17. The apparatus of claim 16, further comprising a second information provider configured to provide the at least one house for sale or rent in a list form by arranging the at least one house for sale or rent in an order starting from a shortest distance from the arrival station.

18. The apparatus of claim 13, further comprising a location provider configured to provide a map to the user terminal after displaying, on the map, the at least one house for sale or rent in correspondence with a location of the at least one house for sale or rent, and displaying, on the map, the at least one route and the at least one available boarding station.

19. A non-transitory computer-readable recording medium storing a computer program for searching for a house for sale or rent, the computer program when executed by a computer performing the steps comprising:
receiving, from a user terminal, by an apparatus for searching for a house for sale or rent, a first place that is a destination, and a house search condition;
extracting at least one route of a public transportation service passing an arrival station corresponding to the first place;
extracting at least one available boarding station satisfying the house search condition from at least one station on the at least one route; and
extracting at least one house for sale or rent having a pre-set relationship with the at least one available boarding station.
